(19) United States
(12) Patent Application Publication
(10) Pub. No.: US 2003/0033238 A1
(43) Pub. Date: Feb. 13, 2003

(54) System, method and article of manufacture for auctioning in a data network environment

(76) Inventors: Lawrence Oskielunas, Lemont, IL (US); Howard Snow, Northbrook, IL (US); Jack Johnson, Summit, NJ (US); William Coyle, Summit, NJ (US); Johnathan Blaser, New Brighton, MN (US); Jonathan Weyers, Bloomington, MN (US); Maureen Peterson, Roseville, MN (US); Julie Wexler, Plymouth, MN (US)

Correspondence Address: MERCHANT & GOULD PC, P.O. BOX 2903, MINNEAPOLIS, MN, 55402-0903, US

(21) Appl. No.: 09/925,758

(22) Filed: Aug. 9, 2001

(51) Int. Cl. G06F 17/60

(52) U.S. Cl. 705/37

(57) ABSTRACT

A method of auctioning data services in a network environment including an exchange system including a supplier list having at least one supplier and a buyer list having at least one includes receiving in the exchange system a service request from a buyer for data services and incentive data from a supplier to supply the data services. The method further includes determining a selected supplier from the supplier list based on the incentive data, creating routing data for the data services to be routed through the selected supplier, and routing the data services through the selected supplier using the routing data.

### FIELD

The present invention relates to network control and more particularly to a moderator that provides auctioning for data transportation services.

### BACKGROUND

Agent based technology has become increasingly important for use with applications designed to interact with a user for performing various computer-based tasks in foreground and background modes. Agent software comprises computer programs that are set on behalf of users to perform routine, tedious, and time-consuming tasks. To be useful to an individual user, an agent must be personalized to the individual user's goals, habits, and preferences. Thus, there exists a substantial requirement for the agent to efficiently and effectively acquire user-specific knowledge from the user and utilize it to perform tasks on behalf of the user.

The concept of agency, or the use of agents, is well established. An agent is a person authorized by another person, typically referred to as a principal, to act on behalf of the principal. In this manner, the principal empowers the agent to perform any of the tasks that the principal is unwilling or unable to perform. For example, an insurance agent might handle all of the insurance requirements for a principal, or a talent agent might act on behalf of a performer to arrange concert dates.

With the advent of the computer, a new domain for employing agents has arrived. Significant advances in the realm of expert systems enable computer programs to act on behalf of computer users to perform routine, tedious, and other time-consuming tasks. These computer programs are referred to as “software agents.”

Moreover, there has been a recent proliferation of computer and communication networks. These networks permit a user to access vast amounts of information and services without, essentially, any geographical boundaries. Thus, a software agent has a rich environment to perform a large number of tasks on behalf of a user. For example, it is now possible for an agent to make an airline reservation, purchase a ticket, and have the ticket delivered directly to a user. Similarly, an agent could scan the Internet and obtain information ranging from the latest sports or news to a particular graduate thesis in applied physics.

In some instances, data is routed across high-speed network lines. Typically, a user, or buyer, of data transportation routes will contract with a supplier, or seller, of the data routes, for a specified time period, bandwidth, quality of service, and price. Such relationships for data transportation between buyers and suppliers have disadvantages. One such disadvantage is that suppliers cannot easily sell and provision bandwidth for particular blocks of time within short notice. Another such disadvantage is that buyers cannot purchase lower-cost bandwidth on such short notice, or in other words, take advantage of a spot market for data transportation. Therefore, a solution to facilitate the buying and selling of data transportation is desirable.

### SUMMARY

In accordance with the present disclosure, the above and other problems are solved by the following:

In one aspect of the present disclosure, a method of auctioning data services in a network environment including an exchange system including a supplier list having at least one supplier and a buyer list having at least one buyer is described. The method includes receiving in the exchange system a service request from a buyer for data services and incentive data from a supplier to supply the data services. The method further includes determining a selected supplier from the supplier list based on the incentive data, creating routing data for the data services to be routed through the selected supplier, and routing the data services through the selected supplier using the routing data.

In another aspect of the present disclosure, a method of auctioning data services in a network environment including an exchange system including a supplier list having at least one supplier and a buyer list having at least one buyer is described. The method includes receiving in the exchange system a service request from a buyer for data services, and incentive data from a supplier to supply the data services. The method further includes determining a selected supplier from the supplier list based on the incentive data, creating routing data for the data services to be routed through the selected supplier, and routing the data services through an automated routing system and the selected supplier using the routing data.

In another aspect of the present disclosure, a method of auctioning data services in a network environment including an exchange system including a supplier list having at least one supplier and a buyer list having at least one buyer is described. The method includes receiving in the exchange system a service request from a buyer for data services and incentive data from a supplier to supply the data services. The method further includes setting a close time for receipt of the incentive data; after setting a close time, determining a selected supplier from the supplier list based on the incentive data; creating routing data for the data services to be routed through the selected supplier; and routing the data services through an automated routing system and the selected supplier using the routing data.

### DESCRIPTION OF THE DRAWINGS

The foregoing and other objects, aspects, and advantages are better understood from the following detailed description of a preferred embodiment of the invention with reference to the drawings, in which:

FIG. 1 is a schematic representation of a general auctioning system in according to aspects of the present disclosure;

FIG. 2 is a schematic representation of a computing system that may be used to implement aspects of the present disclosure;

FIG. 3 is a schematic view of an exemplary system of the invention showing dedicated communication lines from each supplier to the moderator, from the moderator to each of the switches, and a common data link from the moderator to each of the suppliers according to aspects of the present disclosure;

FIG. 4 is a schematic view of an exemplary system of the invention showing the suppliers using a shared data link to provide information to the moderator according to aspects of the present disclosure;

FIG. 5 is a schematic view of an exemplary system of the invention showing switched access from the moderator to each of the switches and to each supplier according to aspects of the present disclosure;

FIG. 6 is a schematic view of an exemplary system of the invention showing use of a shared data facility for communication from the moderator to each of the subscribing switches and to each supplier according to aspects of the present disclosure;

FIG. 7 is a schematic view of an exemplary auctioning system according to aspects of the present disclosure;

FIG. 8 is a flowchart illustrating the logical operations of an auctioning system according to aspects of the present disclosure;

FIG. 9 is a flowchart illustrating the logical operations of a service request according to aspects of the present disclosure;

FIG. 10 is an example user interface screen for entering a service request according to aspects of the present disclosure;

FIG. 11 is a flowchart illustrating the logical operations of an offer according to aspects of the present disclosure; and

FIG. 12 is an example user interface screen for entering an offer according to aspects of the present disclosure.

### DETAILED DESCRIPTION

In the following description of preferred embodiments of the present invention, reference is made to the accompanying drawings that form a part hereof, and in which is shown by way of illustration specific embodiments in which the invention may be practiced. It is understood that other embodiments may be utilized and structural changes may be made without departing from the scope of the present invention.

In general, the present disclosure describes methods, systems, and an article of manufacture containing the methods for an auctioning system for routing data traffic. In general, the auctioning system uses a moderator to collect buyer requests, seller's offers, or bids, to supply the bandwidth for buyer's requests, and the moderator routes the data traffic in accordance therewith. This might be done, for example, by the Moderator provisioning a switch, or the moderator sending the necessary information to a switch provisioning application or system.

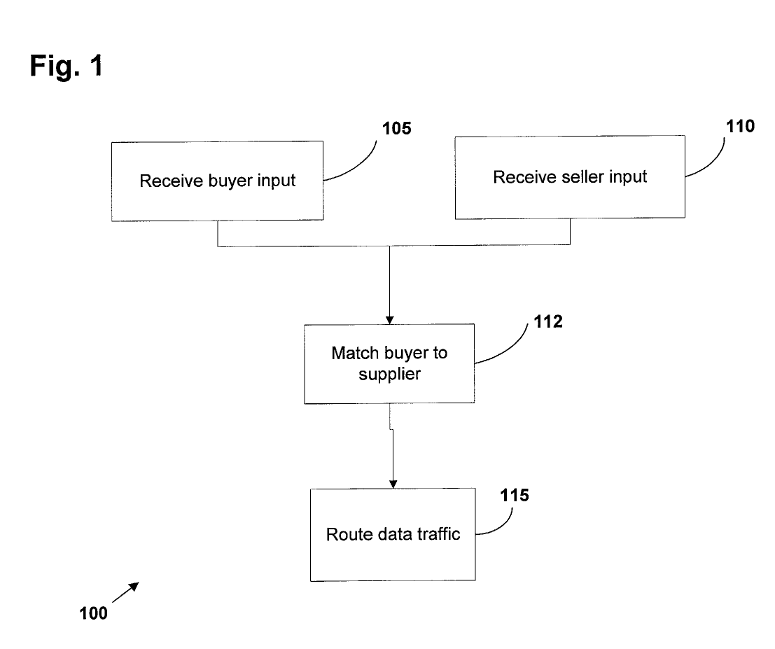

Referring now to FIG. 1, a schematic representation of a general auctioning system 100 is illustrated. A first receive module 105 receives buyer input. The buyer input, or request, might include date and block of time data transportation is needed, bandwidth, and price parameters associated therewith. A second receive module 110 receives supplier offers. A supplier, or several suppliers, might bid to supply data transportation in accordance with the buyer's request or a portion thereof. For example, a supplier might bid to provide a desired service at a specified price, or the supplier might bid to provide only 50% of the requested bandwidth for the desired time. A match module 112 matches buyers to suppliers meeting their needs. A route module 115 routes the data traffic in response to information received by the first and second receive modules 105, 110.

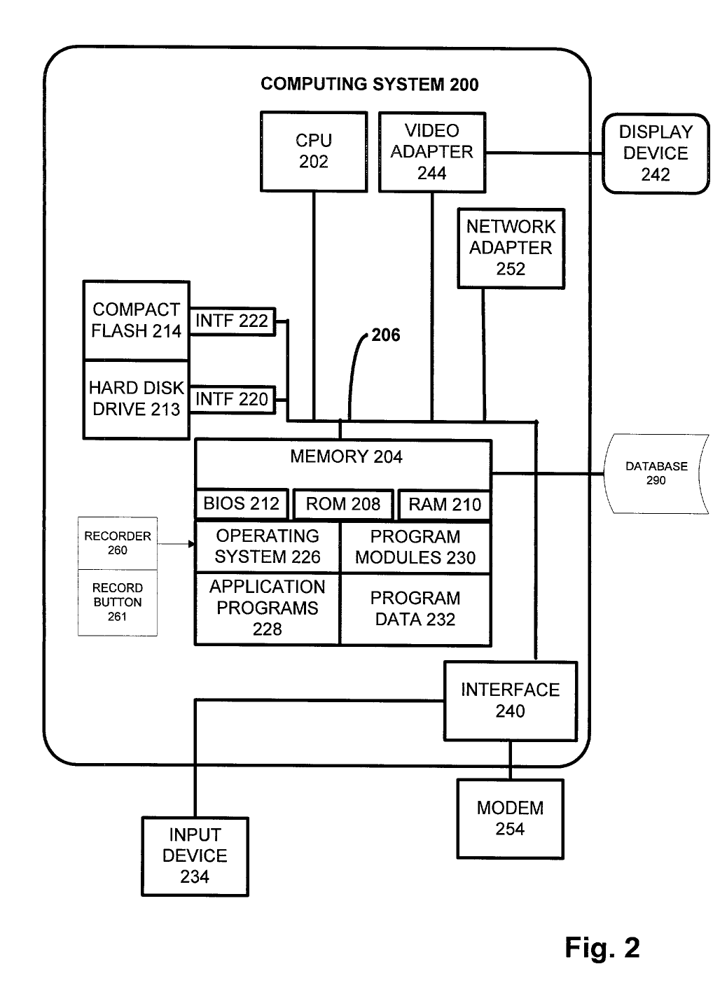

FIG. 2 and the following discussion are intended to provide a brief, general description of a suitable computing environment in which the invention might be implemented. Although not required, the invention is described in the general context of computer-executable instructions, such as program modules, being executed by a computing system, such as an IBM compatible personal computer, Apple Macintosh computer, or a UNIX-based workstation. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

Referring now to FIG. 2, an exemplary environment for implementing embodiments of the present invention includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user might enter commands and information into the computing system 200 through an input device 234. Examples of input devices might include a keyboard, mouse, microphone, joystick, game pad, satellite dish, scanner, touchpad, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254, the network interface, or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a supplier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

A preferred embodiment can be written using JAVA, C, and the C++ language and utilizes object oriented programming methodology. Object oriented programming (OOP) can be also be used. OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures, or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and that are accessed at run-time through a component integration architecture. A component integration architecture is a set of architecture mechanisms that allow software modules in different process spaces to utilize each others' capabilities or functions. This is generally done by assuming a common component object model on which to build the architecture.

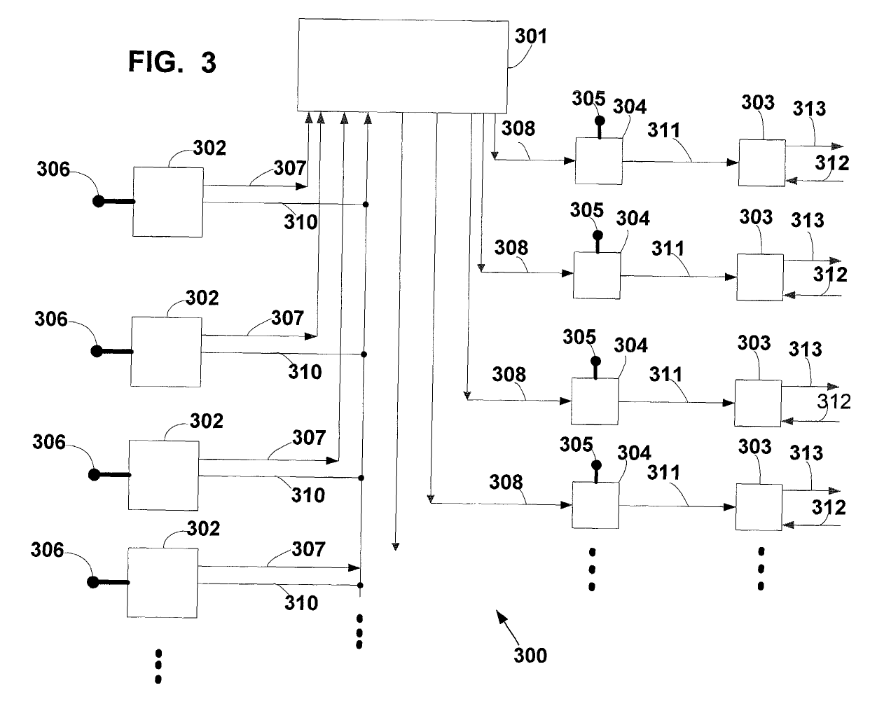

In accordance with a preferred embodiment, the auctioning process is implemented by an agent, or moderator, such as a moderating computing system. FIG. 3 illustrates an exemplary system 300 for carrying out the herein disclosed bidding process, or auction, for data transfer services, in which a moderator 301 administers collection and dissemination of bidding information. The moderator 301 includes at least one computing system, such as that described in conjunction with FIG. 2, with a processing system and a memory system, together with input and output devices, that are systems, process, or people, to communicate with the suppliers' auction management computing systems 302, which are the source of the bidding information.

The suppliers carry data traffic between switches 303. By means of the auctioning system 300, illustrated in FIG. 3, the suppliers bid for data traffic between switches 303. Of course, in some example embodiments, a seller could bid for data traffic between switches and a supplier could carry the data traffic between the switches. In this example, the seller and the supplier are different entities.

The suppliers transmit their bids from their network management computing systems 302 over data links 307, which may be either analog (using modems) or digital, that might include dedicated connections or connections through the Internet. However, the information is usually transmitted in digital form for input into the moderator 301. Preferably, each supplier has a bid administrator who enters offers or bids into each network management computing system 302 through input ports 306 by means, for example, of a keyboard or a data link from a remote site or local computer. In alternative embodiments, network management instructions might be resident in a computing system, such as a knowledge-based expert system.

The moderator 301 receives the bids, processes them in its processing system, and enters them into a database in its memory system by means of the data buses and registers internal to a computing system. The processed bids, applicable to each subscribing switch 303, are analyzed. The selected route is transmitted to the switch 303, by way of a computer 304 (such as the computer described in FIG. 2) adjunct to or associated with the switch 303 over a data link 308. The computer 304 might be resident within the switch, an external component coupled to the switch 304, or the moderator 301 might provision the switch.

The data link 308 is illustrated as a dedicated transmission facility between the moderator 301 and each switch 303. However, any other transmission technology offering a selective way to transmit data from the moderator 301 to the switch may be used, including manually provisioning the switches. By the term “transmission facility,” it is meant a path or channel. The transmission facility might be, for example, a wired link, a radio channel in a wireless system, or a time slot in a digitally multiplexed optical transmission system. The data inputs and outputs of the moderator 301, the network management computers 302, the adjunct computers 304, and the switches 303 are implemented by such devices as interfaces, registers, and modems that are well known.

In the herein disclosed architecture the adjunct computer 304, or switch, receives routing information from the moderator 301, through input port 305. Software in the computer's processor routes the data transmission in accordance with the routing information received from the moderator 301. In some instances, the adjunct computer 304 communicates with the switch 303 over a digital data link, such as a dedicated line from the moderator 301 to the switch 303, or data bus 311. If the switch 303 has enough processing capacity, the function of the adjunct computer 304 may be incorporated in the switch's processor and memory. In this case, the switch must also provide input ports to receive transmission line 308 and input 305 for the switch administrator. It is noted that the switch administrator might be the moderator 301, thereby eliminating the need for a separate input 305.

The moderator 301 also transmits, or provides access to, all or an appropriate subset of the received bids to the network management computers 302 of all or some of the suppliers, or buyers, or both, over the data links 309, 310. The exemplary architecture of FIG. 3 shows a combination of a single output data link 309 and individual supplier input link 310 for this moderator-to-suppliers bid data, indicating that the moderator 301 sends the same data to all suppliers. There are many alternate transmission technologies available to transmit this bid data to all the suppliers, including dedicated bidirectional links between the moderator 301 and each supplier, combining the function of lines 307, 309, and 310.

Analogously, buyers could also be similarly configured between the moderator.

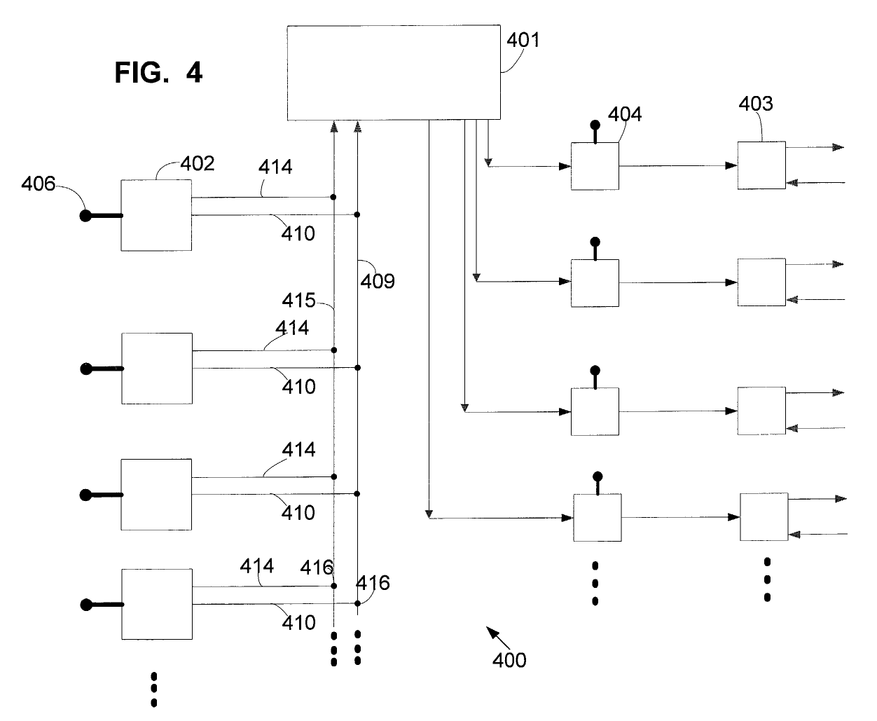

FIG. 4 illustrates an alternative network architecture in which the individual supplier-to-moderator data links 414 share a common data input line 415 into the moderator 401. This can be done, for example, by means of fiber optics using the SONET transmission protocol and ATM technology. This would require an ATM switching module at each junction 416 between the individual supplier links 410, 414 and the common moderator input-output lines 409, 415.

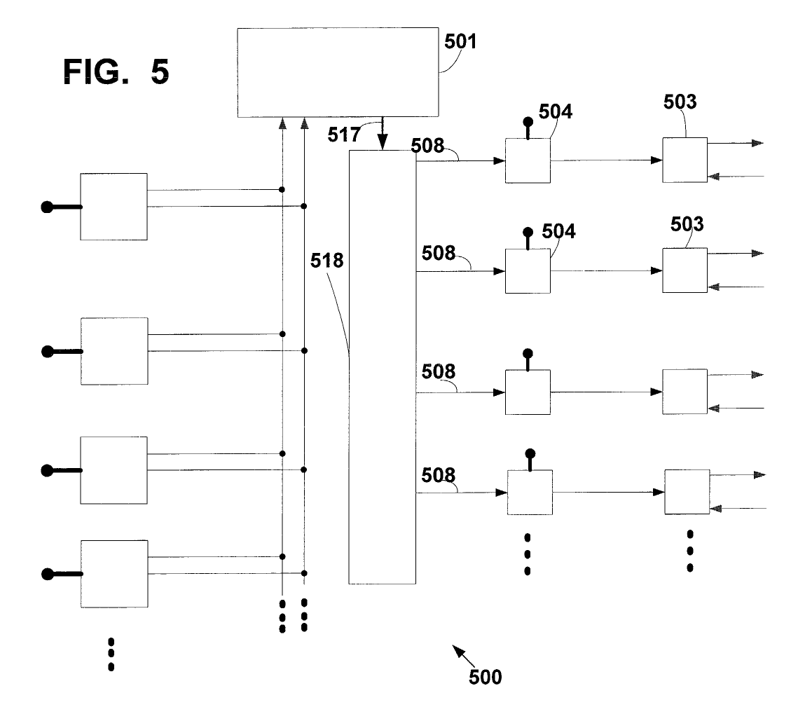

FIG. 5 illustrates an architecture incorporating switched access from the moderator 501 to the switches 503. In this architecture a single moderator output link 517 transmits each subscribing switch's routing information to a switch 518, which might be a dedicated switch. The routing information appropriate to each switch 503 is routed to each individual switch data link 508.

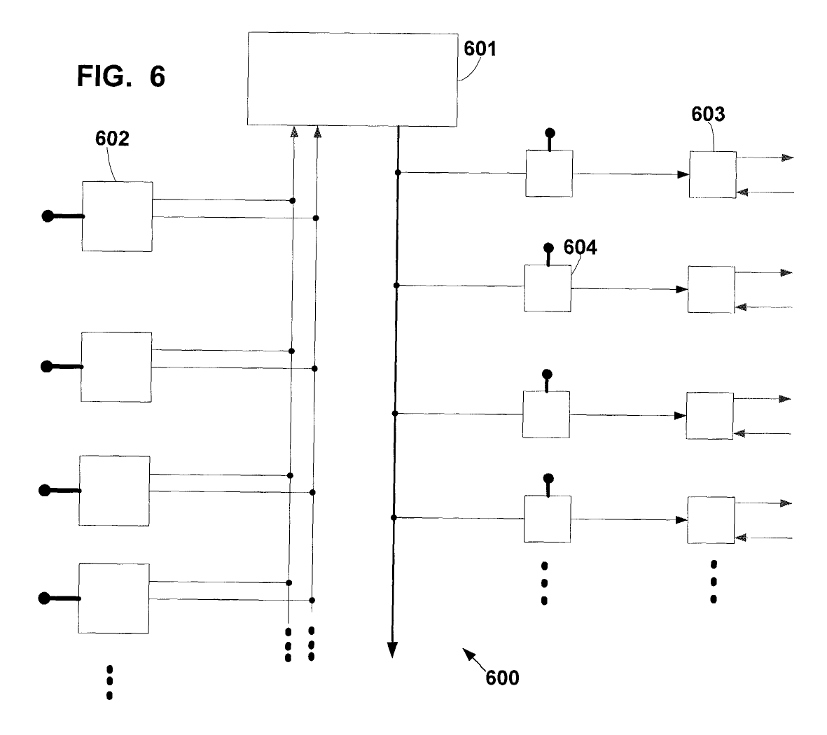

FIG. 6 illustrates use of shared facilities between the moderator 601 and each of the switches 603 and the suppliers' network management computers 602. This could be accomplished, for example, by many known local area network (LAN), metropolitan area network (MAN), the Internet, and other wide area network (WAN) technologies.

The traditional type of communication network is circuit switched. The United States telephone system uses such circuit switching techniques. When a person or a computer makes a telephone call, the switching equipment within the telephone system seeks out a physical path from the originating telephone to the receiver's telephone. A circuit-switched network attempts to form a dedicated connection, or circuit, between these two points by first establishing a circuit from the originating phone through the local switching office, then across trunk lines, to a remote switching office, and finally to the destination telephone. This dedicated connection exists until the call terminates.

Packet switched networks, which predominate the computer network industry, operate in a different fashion. The packet switched networks divide data into small pieces called packets that are multiplexed onto high capacity intermachine connections. A packet is a block of data with a strict upper limit on block size that carries with it sufficient identification necessary for delivery to its destination. Such packets usually contain several hundred bytes of data and occupy a given transmission line for only a few tenths of a millisecond. Delivery of a larger file via packet switching requires that it be broken into many small packets and sent one at a time from one machine to the other. The network hardware delivers these packets to the specified destination, where the software reassembles them into a single file.

Packet switching is used by virtually all computer interconnections because of its efficiency in data transmissions. Packet switched networks use bandwidth on a circuit as needed, allowing other transmissions to pass through the lines in the interim. Furthermore, throughput is increased by the fact that a router or switching office can quickly forward to the next stop any given packet, or portion of a large file, that it receives, long before the other packets of the file have arrived. In message switching, the intermediate router would have to wait until the entire block was delivered before forwarding.

The Internet is composed of a great number of individual networks, together forming a global connection of thousands of computer systems. After understanding that machines are connected to the individual networks, we can investigate how the networks are connected together to form an inter-network, or an internet. At this point, internet gateways and internet routers come into play.

In terms of architecture, two given networks are connected by a computer that attaches to both of them. Internet gateways and routers provide the interconnection necessary to send packets between networks and thus make connections possible. Without these links, data communication through the Internet would not be possible, as the information either would not reach its destination or would be incomprehensible upon arrival. A gateway may be thought of as an entrance to a communications network that performs code and protocol conversion between two otherwise incompatible networks. For instance, gateways transfer electronic mail and data files between networks over the internet.

IP Routers are also computers that connect networks. This is a newer term preferred by vendors. These routers must make decisions as to how to send the data packets it receives to its destination through the use of continually updated routing tables. By analyzing the destination network address of the packets, routers make these decisions. Importantly, a router does not generally need to decide which host or end user will receive a packet; instead, a router seeks only the destination network and thus keeps track of information sufficient to get to the appropriate network, not necessarily the appropriate end user. Therefore, routers do not need to be huge supercomputing systems and are often just machines with small main memories and little disk storage. The distinction between gateways and routers is slight, and current usage blurs the line to the extent that the two terms are often used interchangeably. In current terminology, a gateway moves data between different protocols and a router moves data between different networks. So a system that moves mail between TCP/IP and OSI is a gateway, but a traditional IP gateway (that connects different networks) is a router.

In packet switching systems, routing is the process of choosing a path over which to send packets. As mentioned before, routers are the computers that make such choices. For the routing of information from one host within a network to another host on the same network, the datagrams that are sent do not actually reach the Internet backbone. This is an example of internal routing, which is completely self-contained within the network. The machines outside of the network do not participate in these internal routing decisions.

Indirect delivery is necessary when more than one physical network is involved, in particular when a machine on one network wishes to communicate with a machine on another network. This type of communication is what we think of when we speak of routing information across the Internet backbone. In indirect delivery, routers are required. To send a datagram, the sender must identify a router to which the datagram can be sent, and the router then forwards the datagram towards the destination network. Recall that routers generally do not keep track of the individual host addresses (of which there are millions), but rather just keeps track of physical networks (of which there are thousands). Essentially, routers in the Internet form a cooperative, interconnected structure, and datagrams pass from router to router across the backbone until they reach a router that can deliver the datagram directly.

In a similar fashion to that of the Internet described above, other networks, such as LAN's or WAN's use routers, or switches to route data. In the present disclosure, the moderator sends routing information to switches to route data packets through a data network.

Asynchronous Transfer Mode (ATM) is a networking technology using a high-speed, connection-oriented system for both local area and wide area networks. ATM networks support modern hardware including:

High speed switches that can operate at gigabit (trillion bit) per second speeds to handle the traffic from many computers; and

Optical fibers (versus copper wires) that provide high data transfer rates, with host-to-ATM switch connections running at 100 or 155 Mbps (million bits per second).

ATM incorporates features of both packet switching and circuit switching, as it is designed to carry voice, video, and television signals in addition to data. Pure packet switching technology is not conducive to carrying voice transmissions because such transfers demand more stable bandwidth.

Frame relay systems use packet switching techniques, but are more efficient than traditional systems. This efficiency is partly due to the fact that they perform less error checking than traditional X.25 packet-switching services. In fact, many intermediate nodes do little or no error checking at all and only deal with routing, leaving the error checking to the higher layers of the system. With the greater reliability of today's transmissions, much of the error checking previously performed has become unnecessary. Thus, frame relay offers increased performance compared to traditional systems.

An Integrated Services Digital Network is an “international telecommunications standard for transmitting voice, video, and data over digital lines,” most commonly running at 64 kilobits per second. The traditional phone network runs voice at only 4 kilobits per second. To adopt ISDN, an end user or company must upgrade to ISDN terminal equipment, central office hardware, and central office software. The ostensible goals of ISDN include the following:

1. To provide an internationally accepted standard for voice, data and signaling;

2. To make all transmission circuits end-to-end digital;

3. To adopt a standard out-of-band signaling system; and

4. To bring significantly more bandwidth to the desktop.

The economic choices presented to data service users under this invention depend on offers submitted by suppliers for data traffic over the routes the suppliers serve. Each route is defined by the local switch serving its originating point and the local switch serving its terminating point. A route is further defined by the ports on each switch.

The competing suppliers offer data traffic by transmitting to the moderator the economic incentive each supplier will offer for data traffic over each route it serves (or, at least, each route it wishes to compete for using the bidding process). The route could be a point to point, point to cloud (e.g, the Internet), point to network or service provider, or some other route. The economic incentive presently contemplated as being most usual is the rate (for a specified period of time between two points for a specified bandwidth). However, many other kinds of economic incentive may be offered, such as a credit toward other services (e.g., frequent flyer points) or a credit toward an additional rebate that may be offered if a user's traffic for a given month rises above a threshold. The economic incentive could be a combination of rate and another incentive. But the economic incentive should be selected from a limited set authorized by the provider of the bidding mechanism, because the incentive must be capable of being evaluated by the moderator. A supplier might wish to submit more than one bid for routes that originate at points at which it offers more than one class of service (e.g., different bandwidths, durations, or quality of service). Another reason for submitting multiple offers between the same endpoints is to sell multiple lines to potentially different buyers.

Each bid must be associated with a time period within which the bid will be effective. The rules of the bidding process can be structured in many ways. The following is an example of a possible bidding rule:

a) The day is divided into blocks of time (e.g., minute, hour, day, week, or month) by the bidding service provider and bids are submitted for each block of time. All bids for a given block of time must be submitted prior to a cut-off time that precedes that block of time by a protection interval. Any bid received after the cut-off time is considered to be effective for the next block of time, unless a new bid is subsequently received from the same supplier for that route. The protection interval is needed to permit processing of the information by the moderator and transmission of the routing information to the adjunct computers prior to the bid's start time. For example, if thirty minute blocks of time are auctioned, a five minute protection interval might be appropriate.

The principal data feedback from the moderator to the suppliers is the transmission of bidding data from the moderator to the suppliers. This permits the suppliers to adjust their own bids for any particular route in view of other suppliers' bids for that route. The bids can be adjusted to be higher or lower, dependent on whether the supplier, in view of the state of its network traffic, wishes to further encourage or discourage additional traffic. The supplier might wish to reduce its bid, for example, to encourage additional traffic on an underutilized data line, or increase its bid to discourage traffic over a facility approaching a full state. The supplier can also pull an offer if the supplier no longer has the capacity offered. Depending on the transmission and computer technologies used, transmission back to the suppliers could also be accomplished by posting all bids on a bulletin board system, making them available for retrieval by the suppliers.

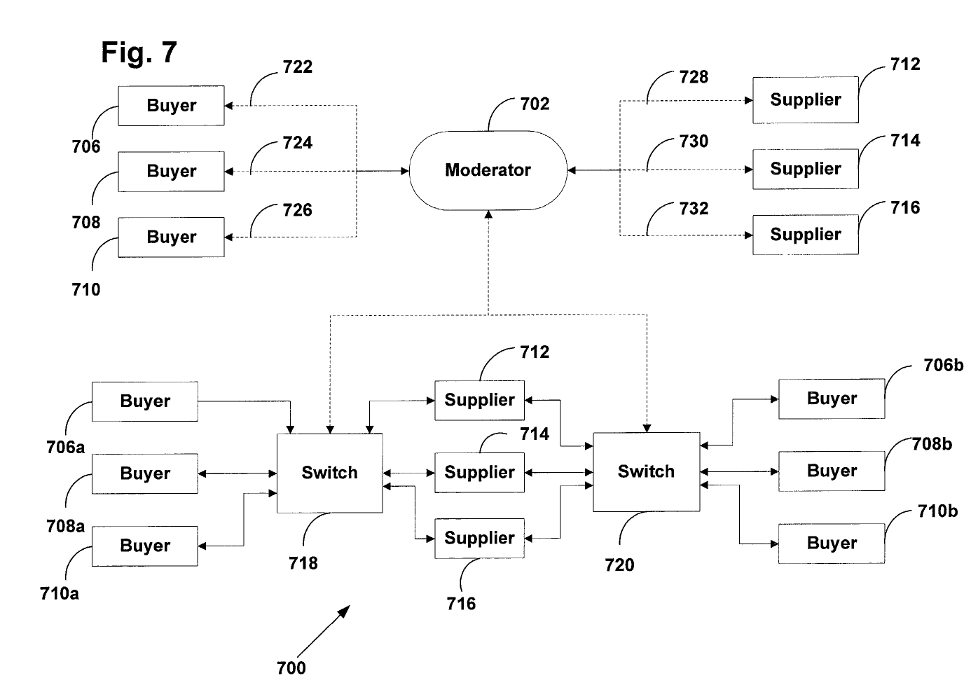

FIG. 7 illustrates a general representation of an auctioning system 700 according to an example embodiment of the present disclosure. In this example, the auctioning system 700 includes a moderator 702, a first buyer 706, a second buyer 708, a third buyer 710, a first supplier 712, a second supplier 714, a third supplier 716, a first switch 718, and a second switch 720. The first and second switches 718, 720 can be switches, interconnection gateways, or routers. The first and second switches 718, 720 correspond to terminal points, for example, Los Angeles and New York City, respectively.

The moderator 702 receives a first service request 722 from the first buyer 706. Likewise, the moderator 702 receives a second service request 724 from the second buyer 708 and a third service request 726 from the third buyer 720. The first service request 733, from the first buyer 706, specifies that the first buyer 706 wishes to purchase data transportation between the first and second switches 718, 720, or between Los Angeles and New York City.

The moderator 702 also receives first, second, and third offers 728, 730, 732 from the first, second, and third suppliers 712, 714, 716, respectively to supply the first service request 722 requested by the first buyer 706. The offers 728, 730, 732 can also be automatched to other requests that satisfy, or partially satisfy, a standing request. The offers 728, 730, 732 can also be standing offers for purchase by another buyer, for example, the third buyer 720. The moderator 702 determined that the first supplier 712 is the preferred supplier using some business logic; for example, the first supplier 712 had the lowest cost offer to supply the first service request 722.

Preferably, the moderator 702 provisions the first and second switches 718, 720 to route the data service through the preferred supplier, the first supplier 712 connecting the first buyer's 706 terminal points, Los Angeles and New York City. Thus, the moderator 702 took bids from the first, second, and third suppliers 712, 714, 716 to supply the first service request 722. The moderator 702 determined that the first supplier 712 was the preferred supplier and routed the data transportation service through the first supplier's network 712.

A buyer, for example, the first buyer 706, can resell the data route to another buyer, for example, the second buyer 708.

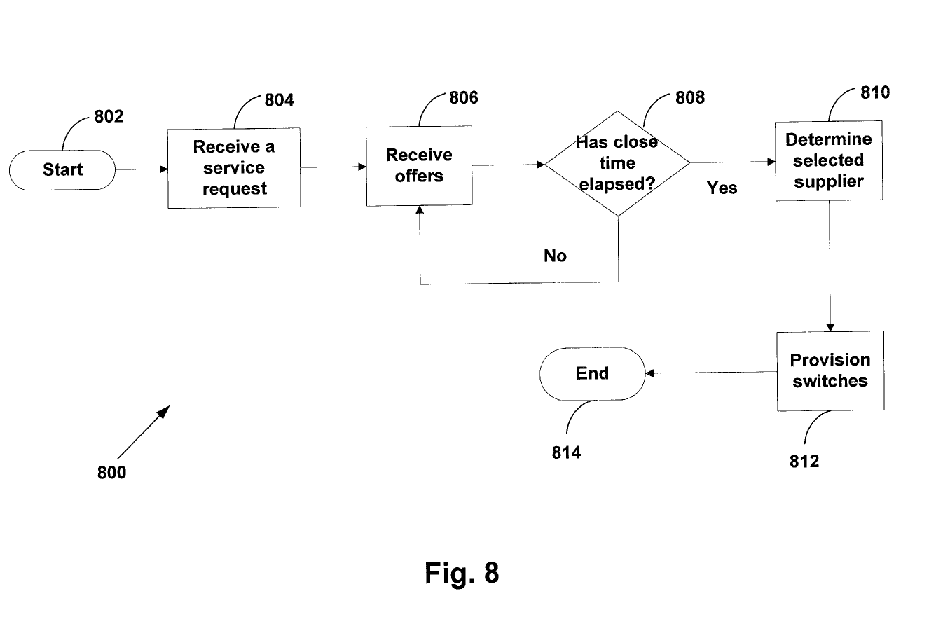

FIG. 8 illustrates an example operational flow for the auctioning system 700 of FIG. 7. FIG. 8 is a flow chart representing logical operations of an auctioning system 800. Entrance to the operational flow begins at a flow connection 802. A request module 804 receives a service request, such as first, second, and third service requests 722, 724, 726 of FIG. 7, from a buyer, such as first, second, and third buyers 706, 706, 710, respectively, of FIG. 7.

An offer module 806 receives offers, such as first, second, and third offers 728, 730, 732 of FIG. 7, from suppliers, such as first, second, and third suppliers 712, 714, 716, respectively, of FIG. 7. A time operation 808 determines if the closing time has passed for the receipt of offers, according to the service request received by the request 804. As will be explained in more detail below, a service request typically contains a closing time for the receipt of offers. In the event that a closing time is not specified in the service request, the auctioning system 800 can set closing times. In some embodiments, the auctioning system 800 will always set the closing times for the receipt of bids. By allowing the auctioning system 800 to set the closing time, the auctioning system 800 can load balance the auctioning system, spreading out the closing times. Spreading out the closing times also allows competing suppliers worldwide to compete for a request at a reasonable local time of day.

If the time operation 808 detects that the closing time has not elapsed, operational flow branches “NO” to the offer module 806. Operational flow proceeds as previously described. If the time operation 808 detects that the closing time has elapsed, operational flow branches “YES” to a preferred module 810. In this fashion, the auctioning system 800 continues to receive offers in the offer module 806 until the specified closing time is reached.

The preferred module 810 determines a preferred supplier. By the term “preferred supplier,” it is meant a supplier who the auctioning system 800 determines best satisfies the service request received by the request module 804. Typically, the preferred supplier will be the supplier that has the lowest cost to satisfy the service request. However, many other parameters can be used to determine the preferred supplier. For example, one particular supplier might have a better quality data transportation system than other suppliers. In addition, the buyer could set priority parameters (e.g., price or quality).

A provision module 812 provisions the switches, such as first and second switches 718, 720 of FIG. 7. In other words, the provision module 812 routes the data between a buyer's terminal points through the preferred supplier, as illustrated in FIG. 7. Operational flow ends at terminal point 814.

It is noted that the auctioning system 800 can also check and review offers to ensure that suppliers do not provide incentive data for data services beyond the suppliers available bandwidth. In other words, the auctioning system 800 can track the bandwidth utilization for the suppliers to ensure that the suppliers do not oversell their bandwidth.

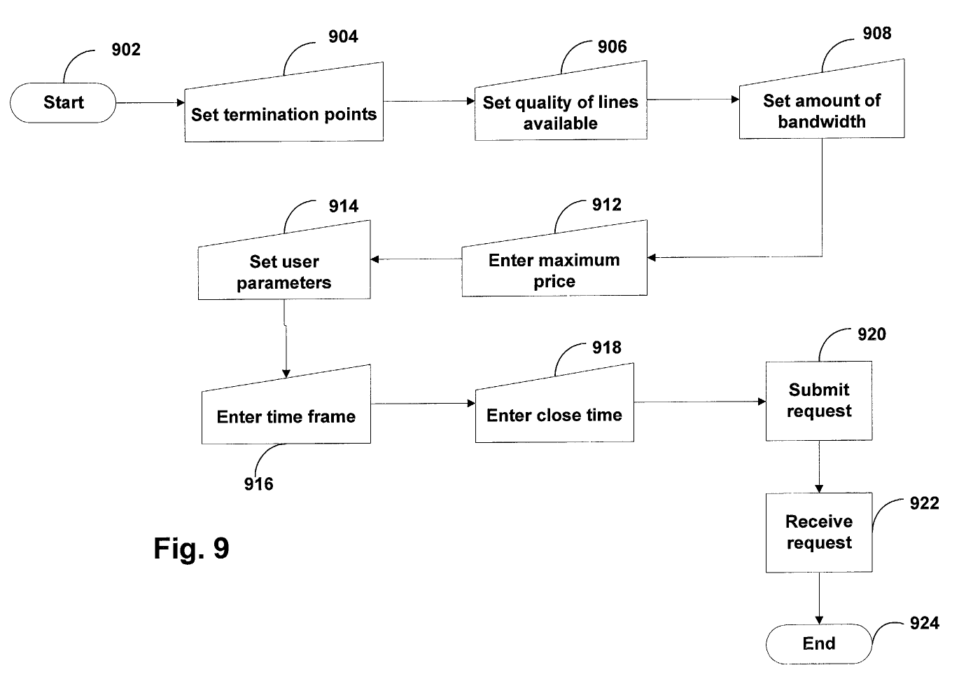

FIG. 9 illustrates example components of a service request, such as the one received by the request module 804 of FIG. 8. Entrance to the operational flow begins at a flow connection 902. Preferably, a buyer creates a request for data transportation services. At block 904, the buyer sets the termination points for the data transportation service. The termination points include first and second endpoints and preferably corresponding first and second ports within the endpoints. At block 906, the buyer sets the quality of lines available. The different quality of lines might include, for example, bulk data and premium video, that could relate to latency, jitter, etc. At block 908, the buyer sets the amount of bandwidth. The type of lines indicate the desired bandwidth, for example a T-1 line has a bandwidth of 1.544 megabits per second (Mbps).

At block 912, the buyer can enter a maximum, or ceiling, price that the buyer is willing to pay for the specified service, that can be displayed to suppliers. This ceiling price can be modified during the duration of the request. At block 914, the buyer sets different user parameters. For example, the buyer might indicate that the buyer does not want his company name displayed to suppliers, or not display the ceiling price. At block 916, the buyer enters the time frame for the desired service. Preferably, the buyer enters the start and end dates. Additionally, the buyer might also enter the start and end times within the start and end dates. At block 918, the buyer enters the closing time for receiving bids to supply the requested service.

It is noted that a commit time could also be utilized. A commit time prohibits the buyer from removing a request and/or a seller from removing an offer during some pre-specified time period for the closing time. At block 920, the buyer submits the request to a moderator, such as the moderator 702 of FIG. 7. It is noted that any or all of the above data entries can be manually input into the moderator or submitted to the moderator electronically.

At block 922, the moderator receives the request 922, including a request confirmation. The operational flow ends at termination point 924.

In one example embodiment, buyers can specify whom they are willing to buy from, and sellers can specify whom they are willing to sell to. This concept is referred to as profiling. The Moderator only matches offers to requests if both parties agree to do business with each other. Other parameters could be used to limit matches, such as credit rating, credit limits, complaints, etc.

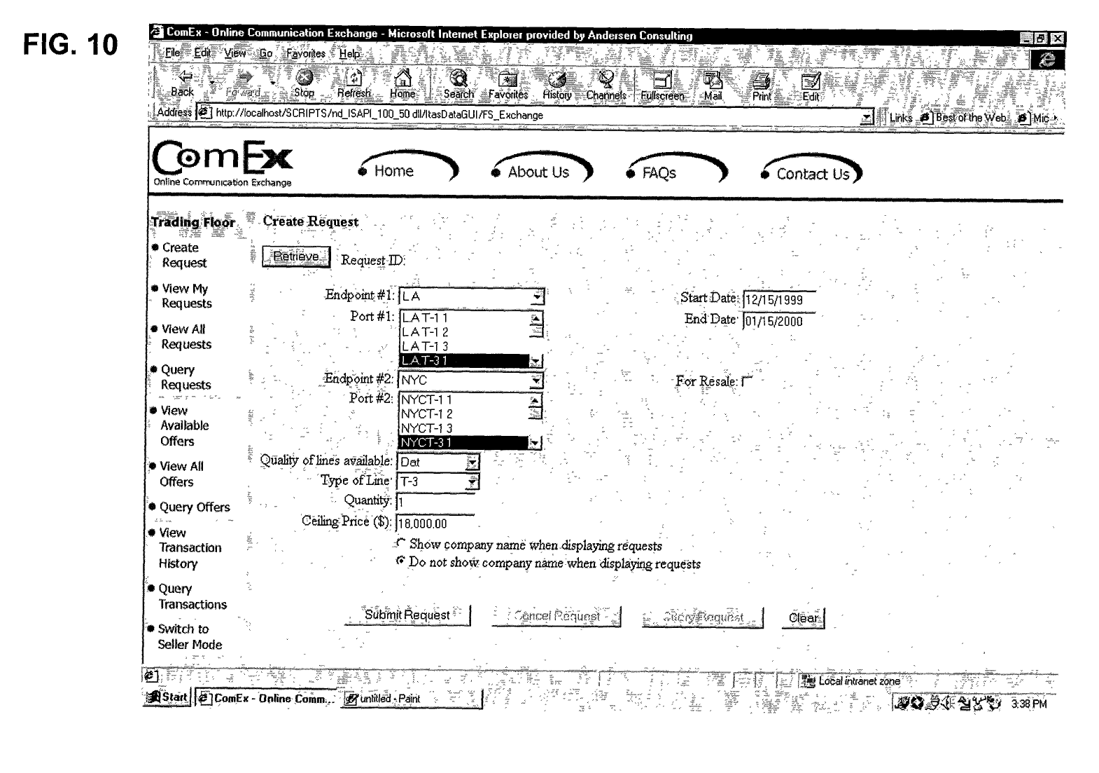

The operational flow described in connection with FIG. 9 may best be understood in terms of an application example. FIG. 10 illustrates an example user interface screen for entering a buyer's request. Referring now to FIGS. 9 and 10, at block 904, the buyer sets a first end point as Los Angeles and a first port as LAT-31. The buyer also sets a second end point as New York City and a second port at NYCT-31. At block 906, the buyer selects a data line. At block 908, the buyer sets the type of line as a T-3 line. At block 910, the buyer selects a quantity of one T-3 line. At block 912, the buyer enters a ceiling price of $18,000. At block 914, the buyer sets his company name to not be shown to suppliers. At block 916, the buyer enters the start date as Dec. 15, 1999 and the end date as Jan. 5, 2000. At block 918, the buyer sets the closing time for bids as Dec. 14, 1999. At block 920, the buyer submits the request to the moderator.

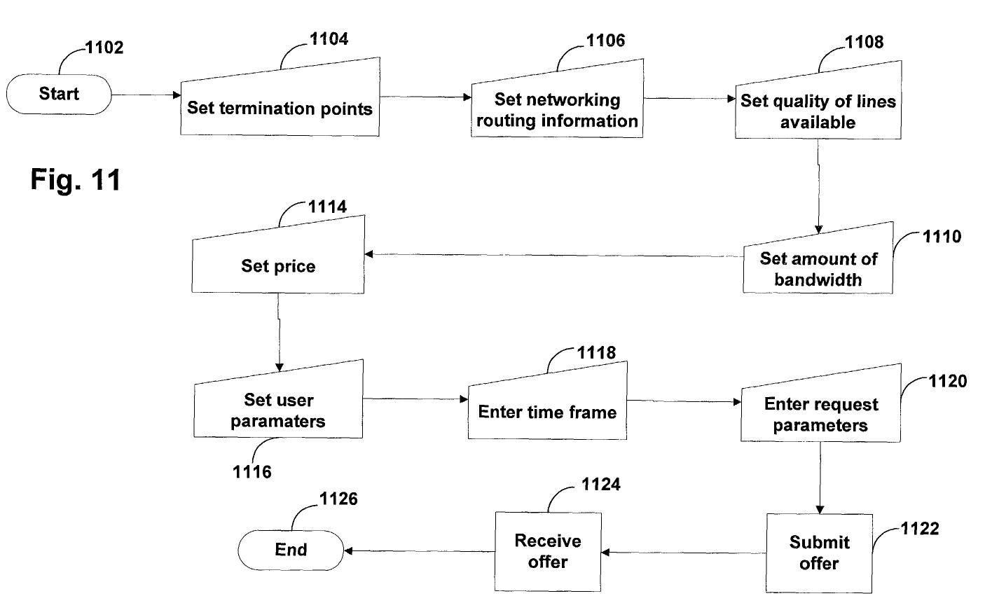

FIG. 11 illustrates example components of an offer, such as the offers received by the offer module 806 of FIG. 8. Entrance to the operational flow begins at a flow connection 1102. A supplier creates an offer to supply data transportation services in accordance with a service request, such as the service request received by the request module 804 of FIG. 8. At block 1104, the supplier sets the termination points for the data transportation service. The termination points include first and second endpoints. At block 1106, the supplier sets the network routing information on which it will carry the data. At block 1108, the supplier sets the quality of lines available. At block 1110, the supplier sets the amount of bandwidth. The type of lines indicate the provided bandwidth, for example a T-1 line. It is noted that if a supplier if responding to a request, some of the data can be pre-populated. For example, the termination points, quality, start and end dates and times can be pre-populated of the supplier in the response.

At block 1114, the supplier enters a price to supply the specified service. At block 1116, the supplier sets different user parameters. For example, the supplier might indicate that the supplier does not want his company name displayed to buyers. At block 1118, the supplier enters the time frame for the offered service. Preferably, the supplier enters the start and end dates. Additionally, the supplier might also enter the start and end times within the start and end dates. At block 1120, the supplier can select whether this offer is good for any request of whether it is good for a specific request. Thus, an offer can be matched with any corresponding requests already entered by a buyer or can be specified to be for a certain request. If the supplier wishes to make the offer good for only a specific request, the supplier enters the request number. At block 1122, the supplier submits the offer to a moderator, such as the moderator 702 of FIG. 7. It is noted that any or all of the above data entries can be manually input into the moderator or submitted to the moderator electronically.

At block 1124, the moderator receives the offer 1124, including an offer confirmation. The operational flow ends at termination point 1126.

The offer process described in connection with FIG. 11 can be automated or manual. Other offers can be monitored and an individual offer could be modified automatically accordingly to provide the data service.

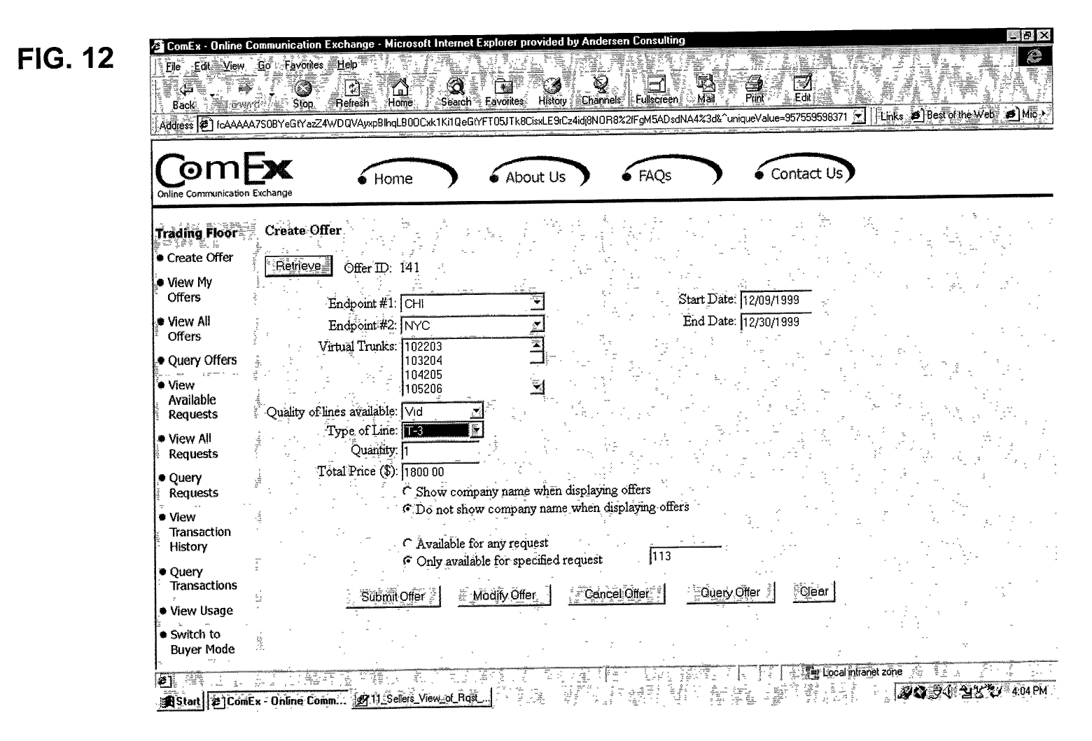

The operational flow described in connection with FIG. 11 may best be understood in terms of an application example. FIG. 12 illustrates an example user interface screen for entering a supplier's offer. Referring now to FIGS. 11 and 12, at block 1104, the supplier sets a first end point as Chicago. The supplier also sets a second end point as New York City. At block 1106, the supplier sets a virtual trunk that the supplier will use to supply the data service, for example trunk 102203. At block 1108, the supplier selects a video quality. At block 1110, the supplier sets the bandwidth. At block 1112, the supplier selects a quantity of one T-3 line. At block 1114, the supplier enters a price of $1800 to supply the data transportation service. At block 1116, the supplier sets his company name to not be shown to suppliers. At block 1118, the supplier enters the start date as Dec. 9, 1999 and the end date as Dec. 30, 1999. At block 1120, the supplier selects that this offer is only good for request 113. At block 1122, the supplier submits the offer to the moderator.

At block 1124, the moderator receives the offer 1122.

In one example embodiment, an off-exchange functionality can be implemented in which the auctioning system described herein is used to provision switches based on pre-arranged agreements between buyers and suppliers. Thus, an auction does not happen but the data is routed according to the above described methods and systems.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of auctioning data services in a network environment including an exchange system including a supplier list having at least one supplier and a buyer list having at least one buyer, the method comprising:
receiving in the exchange system:
a service request from a buyer for data services; and
incentive data from a supplier to supply the data services;
determining a selected supplier from the supplier list based on the incentive data;
creating routing data for the data services to be routed through the selected supplier; and
routing the data services through the selected supplier using the routing data;
whereby data services are provided in an incentive-driven environment, allowing flexibility in supplier relationships for the buyer and providing improved utilization and yield management opportunities for the selected supplier.

2. A method according to claim 1 wherein data services includes at least one of data transportation services and data application services.

3. A method according to claim 1 wherein the exchange system includes a moderator system.

4. A method according to claim 3 wherein the moderator system includes a moderator computing system.

5. A method according to claim 4 wherein the exchange system includes switches.

6. A method according to claim 1 wherein the exchange system includes a routing system to provide data transportation services for the buyer through the selected supplier.

7. A method according to claim 6 wherein the routing system is configured automatically by the exchange system.

8. A method according to claim 1 wherein creating includes automatically generating routing data.

9. A method according to claim 1 wherein the service request specifies a ceiling price for the data transportation services.

10. A method according to claim 9 wherein the buyer specifies whether the ceiling price is made available to the supplier.

11. A method according to claim 1 wherein the incentive data includes a decrement amount allowing the incentive data to change according to predetermined rules.

12. A method according to claim 1 wherein the routing data includes first and second endpoints.

13. A method according to claim 12 wherein the first and second endpoints include first and second ports respectively.

14. A method according to claim 1 wherein the routing data includes a trunk line specification.

15. A method according to claim 1 wherein the service request includes a specified closing time for the receipt of incentive data from the supplier.

16. A method according to claim 1 further comprising setting by the exchange system a closing time for receiving the incentive data.

17. A method according to claim 1 wherein determining includes determining by the buyer the selected supplier based on the incentive data.

18. A method according to claim 1 wherein determining includes determining by a moderating system in the exchange system the selected supplier.

19. A method according to claim 1 wherein incentive data includes at least one of economic incentive data, supplier information, and duration of the data transportation services.

20. A method according to claim 19 wherein the incentive data includes a time period for which the incentive data is valid.

21. A method according to claim 20 wherein the supplier information can be conditionally provided to the buyer.

22. A method according to claim 1 further comprising providing information regarding the selected supplier to the supplier list.

23. A method according to claim 1 further comprising providing all or a subset of the incentive data to all or a subset of the supplier list or buyer list.

24. A method according to claim 1 further comprising:
providing a view of all or a subset of the service requests and incentive data for closed transactions to all or a subset of the supplier list or buyer list.

25. A method according to claim 1 wherein:
providing a view includes providing a view of all or a subset of the open service requests and open incentive data to all or a subset of the supplier list or buyer list.

26. A method according to claim 25 wherein open service requests and open incentive data includes partially unfulfilled service requests and incentive data.

27. A method according to claim 1 further comprising:
committing the service request after a specified amount of time beyond which the buyer cannot revoke the service request thereby giving the seller a guaranteed sale to compete for.

28. A method according to claim 1 further comprising receiving resell information as derivative routing data.

29. A method according to claim 1 wherein data services includes analog and digital information.

30. A method according to claim 1 further comprising:
defining a member profile by the buyer or supplier in the exchange system by entering parameters that allow the buyer or supplier to define selection criteria; and
wherein determining a selected supplier includes determining a selected supplier from the supplier list based on the incentive data and by applying the buyer's selection criteria against the supplier list and each supplier's selection criteria against the buyer.

31. A method according to claim 30 wherein defining a member profile includes entering parameters that allow the buyer or supplier to define selection criteria that includes at least one of supplier identifications, credit limits, and type of transmission line.

32. A method according to claim 30 further comprising:
providing a limited view of the buyer list or seller list based on the member profile.

33. A method according to claim 30 wherein defining a member profile includes limiting the supplier list through which the selected supplier is determined.

34. A method according to claim 33 further comprising:
blocking redefining the member profile to include buyers or sellers limited by the member profile for a protection interval in order to prevent use of the member profile to uncover identities of other companies.

35. A method according to claim 1 further comprising:
querying the exchange system by the at least one supplier or the at least one buyer to search for specific service request parameters or incentive data parameters;
whereby the at least one buyer and the at least one supplier can facilitate the submission of service requests and incentive data.

36. A method according to claim 1 wherein the exchange system includes a billing system.

37. A method according to claim 1 further comprising:
notifying the buyer list or supplier list of a new buyer or supplier.

38. A method according to claim 1 further comprising:
tracking bandwidth utilization for the supplier to ensure that the supplier does not provide incentive data for data services beyond the suppliers available bandwidth.

39. A method of auctioning data services in a network environment including an exchange system including a supplier list having at least one supplier and a buyer list having at least one buyer, the method comprising:
receiving in the exchange system:
a service request from a buyer for data services; and
incentive data from a supplier to supply the data services;
determining a selected supplier from the supplier list based on the incentive data;
creating routing data for the data services to be routed through the selected supplier; and
routing the data services through an automated routing system and the selected supplier using the routing data;
whereby data services are provided in an incentive-driven environment, allowing flexibility in supplier relationships for the buyer and providing improved utilization and yield management opportunities for the selected supplier.

40. A method according to claim 39 wherein data services includes at least one of data transportation services and data application services.

41. A method according to claim 39 wherein the exchange system includes a moderator system.

42. A method according to claim 41 wherein the moderator system includes a moderator computing system.

43. A method according to claim 42 wherein the exchange system includes switches.

44. A method according to claim 39 wherein creating includes automatically generating routing data.

45. A method according to claim 39 wherein the service request specifies a ceiling price for the data transportation services.

46. A method according to claim 45 wherein the buyer specifies whether the ceiling price is made available to the supplier.

47. A method according to claim 39 wherein the incentive data includes a decrement amount allowing the incentive data to change according to predetermined rules.

48. A method according to claim 39 wherein the routing data includes first and second endpoints.

49. A method according to claim 48 wherein the first and second endpoints include first and second ports respectively.

50. A method according to claim 39 wherein the routing data includes a trunk line specification.

51. A method according to claim 39 wherein the service request includes a specified closing time for the receipt of incentive data from the supplier.

52. A method according to claim 39 further comprising setting by the exchange system a closing time for receiving the incentive data.

53. A method according to claim 39 wherein determining includes determining by the buyer the selected supplier based on the incentive data.

54. A method according to claim 39 wherein determining includes determining by a moderating system in the exchange system the selected supplier.

55. A method according to claim 39 wherein incentive data includes at least one of economic incentive data, supplier information, and duration of the data transportation services.

56. A method according to claim 55 wherein the incentive data includes a time period for which the incentive data is valid.

57. A method according to claim 56 wherein the supplier information can be conditionally provided to the buyer.

58. A method according to claim 39 further comprising providing information regarding the selected supplier to the supplier list.

59. A method according to claim 39 further comprising providing all or a subset of the incentive data to all or a subset of the supplier list or buyer list.

60. A method according to claim 39 further comprising:
providing a view of all or a subset of the service requests and incentive data for closed transactions to all or a subset of the supplier list or buyer list.

61. A method according to claim 60 wherein:
providing a view includes providing a view of all or a subset of the open service requests and open incentive data to all or a subset of the supplier list or buyer list.

62. A method according to claim 61 wherein open service requests and open incentive data includes partially unfulfilled service requests and incentive data.

63. A method according to claim 39 further comprising:
committing the service request after a specified amount of time beyond which the buyer cannot revoke the service request thereby giving the seller a guaranteed sale to compete for.

64. A method according to claim 39 further comprising receiving resell information as derivative routing data.

65. A method according to claim 39 wherein data services includes analog and digital information.

66. A method according to claim 39 further comprising:
defining a member profile by the buyer or supplier in the exchange system by entering parameters that allow the buyer or supplier to define selection criteria; and
wherein determining a selected supplier includes determining a selected supplier from the supplier list based on the incentive data and by applying the buyer's selection criteria against the supplier list and each supplier's selection criteria against the buyer.

67. A method according to claim 66 wherein defining a member profile includes entering parameters that allow the buyer or supplier to define selection criteria that includes at least one of supplier identifications, credit limits, and type of transmission line.

68. A method according to claim 66 further comprising:
providing a limited view of the buyer list or seller list based on the member profile.

69. A method according to claim 66 wherein defining a member profile includes limiting the supplier list through which the selected supplier is determined.

70. A method according to claim 69 further comprising:
blocking redefining the member profile to include buyers or sellers limited by the member profile for a protection interval in order to prevent use of the member profile to uncover identities of other companies.

71. A method according to claim 39 further comprising:
querying the exchange system by the at least one supplier or the at least one buyer to search for specific service request parameters or incentive data parameters;
whereby the at least one buyer and the at least one supplier can facilitate the submission of service requests and incentive data.

72. A method according to claim 39 wherein the exchange system includes a billing system.

73. A method according to claim 39 further comprising:
notifying the buyer list or supplier list of a new buyer or supplier.

74. A method according to claim 39 further comprising:
tracking bandwidth utilization for the supplier to ensure that the supplier does not provide incentive data for data services beyond the suppliers available bandwidth.

75. A method of auctioning data services in a network environment including an exchange system including a supplier list having at least one supplier and a buyer list having at least one buyer, the method comprising:
receiving in the exchange system:
a service request from a buyer for data services; and
incentive data from a supplier to supply the data services;
setting a close time for receipt of the incentive data;
after setting a close time, determining a selected supplier from the supplier list based on the incentive data;
creating routing data for the data services to be routed through the selected supplier; and
routing the data services through an automated routing system and the selected supplier using the routing data;
whereby data services are provided in an incentive-driven environment, allowing flexibility in supplier relationships for the buyer and providing improved utilization and yield management opportunities for the selected supplier.

76. A method according to claim 75 wherein data services includes at least one of data transportation services and data application services.

77. A method according to claim 75 wherein the exchange system includes a moderator system.

78. A method according to claim 77 wherein the moderator system includes a moderator computing system.

79. A method according to claim 75 wherein the exchange system includes switches.

80. A method according to claim 75 wherein creating includes automatically generating routing data.

81. A method according to claim 75 wherein the service request specifies a ceiling price for the data transportation services.

82. A method according to claim 81 wherein the buyer specifies whether the ceiling price is made available to the supplier.

83. A method according to claim 75 wherein the incentive data includes a decrement amount allowing the incentive data to change according to predetermined rules.

84. A method according to claim 75 wherein the routing data includes first and second endpoints.

85. A method according to claim 84 wherein the first and second endpoints include first and second ports respectively.

86. A method according to claim 75 wherein the routing data includes a trunk line specification.

87. A method according to claim 75 wherein determining includes determining by the buyer the selected supplier based on the incentive data.

88. A method according to claim 75 wherein determining includes determining by a moderating system in the exchange system the selected supplier.

89. A method according to claim 75 wherein incentive data includes at least one of economic incentive data, supplier information, and duration of the data transportation services.

90. A method according to claim 89 wherein the incentive data includes a time period for which the incentive data is valid.

91. A method according to claim 90 wherein the supplier information can be conditionally provided to the buyer.

92. A method according to claim 75 further comprising providing information regarding the selected supplier to the supplier list.

93. A method according to claim 75 further comprising providing all or a subset of the incentive data to all or a subset of the supplier list or buyer list.

94. A method according to claim 75 further comprising:
providing a view of all or a subset of the service requests and incentive data for closed transactions to all or a subset of the supplier list or buyer list.

95. A method according to claim 94 wherein:
providing a view includes providing a view of all or a subset of the open service requests and open incentive data to all or a subset of the supplier list or buyer list.

96. A method according to claim 95 wherein open service requests and open incentive data includes partially unfulfilled service requests and incentive data.

97. A method according to claim 75 further comprising:
committing the service request after a specified amount of time beyond which the buyer cannot revoke the service request.

98. A method according to claim 75 further comprising receiving resell information as derivative routing data.

99. A method according to claim 75 wherein data includes analog and digital information.

100. A method according to claim 75 further comprising:
defining a member profile by the buyer or supplier in the exchange system by entering parameters that allow the buyer or supplier to define selection criteria; and
wherein determining a selected supplier includes determining a selected supplier from the supplier list based on the incentive data and by applying the selection criteria against the supplier list.

101. A method according to claim 100 wherein defining a member profile includes entering parameters that allow the buyer or supplier to define selection criteria that includes at least one of supplier identifications, dollar amounts, credit limits, and type of transmission line.

102. A method according to claim 100 further comprising:
providing a limited view of the buyer list or seller list based on the member profile.

103. A method according to claim 100 wherein defining a member profile includes limiting the supplier list through which the selected supplier is determined.

104. A method according to claim 103 further comprising:
blocking redefining the member profile to include buyers or sellers limited by the member profile for a protection interval.

105. A method according to claim 75 further comprising:
querying the exchange system by the at least one supplier or the at least one buyer to search for specific service request parameters or incentive data parameters;
whereby the at least one buyer and the at least one supplier can facilitate the submission of service requests and incentive data.

106. A method according to claim 75 wherein the exchange system includes a billing system.

107. A method according to claim 75 further comprising:
notifying the buyer list or supplier list of a new buyer or supplier.

108. A method according to claim 75 further comprising:
tracking bandwidth utilization for the supplier to ensure that the supplier does not provide incentive data for data services beyond the suppliers allocated bandwidth.
